(19) United States
(12) Patent Application Publication
(10) Pub. No.: US 2007/0220812 A1
(43) Pub. Date: Sep. 27, 2007

(54) Door core module

(76) Inventors: Jeffrey Valentage, Royal Oak, MI (US); Joseph Gustaaf Marie Flendrig, Brussels (BE)

Correspondence Address: ExxonMobil Chemical Company;Law Technology, P.O. Box 2149, Baytown, TX, 77522-2149, US

(21) Appl. No.: 11/704,129

(22) Filed: Feb. 8, 2007

Related U.S. Application Data
(63) Continuation-in-part of application No. 11/590,307, filed on Oct. 31, 2006.
(60) Provisional application No. 60/785,026, filed on Mar. 23, 2006.

(51) Int. Cl. B60J 5/04

(52) U.S. Cl. 49/502

(57) ABSTRACT

A door core module and integrated door system are provided. In at least one specific embodiment, the core module includes a molded panel having two or more channels injection molded therein, and a plurality of notches formed in an upper surface of the panel arranged about the panel to provide control break points. In at least one specific embodiment, the integrated door system includes an outer panel, an inner panel, and a core module. The core module includes two or more channels injection molded therewith and a plurality of notches formed in an upper surface thereof. The notches are arranged about the core module to provide control break points. Further, the core module is adapted to attach to either the outer panel or the inner panel.

### CROSS REFERENCE TO RELATED APPLICATIONS

This application claims the benefit of and priority from U.S. Ser. No. 60/785,026, filed Mar. 23, 2006. This application is also a continuation-in-part of 11/590,307, filed Oct. 31, 2006. All of the above applications are fully incorporated herein by reference.

### BACKGROUND OF THE INVENTION

1. Field of the Invention

This invention relates to door systems. More particularly, embodiments of the present invention generally relate to door systems for vehicles, such as automobiles, specifically cars and

2. Description of the Related Art

Conventional doors for vehicles include numerous components that are assembled and attached to one another. FIG. 1 shows a schematic illustration of a conventional door. As shown, the door 100 typically includes an interior trim panel 110, steel inner panel 120, steel intrusion beam 130, inner steel reinforcement 140, outer steel reinforcement 142, latch assembly 145A-C, and steel outer panel 150. The inner reinforcement 140, outer reinforcement 142, and intrusion beam 130 are stamped, welded together, and painted. Numerous hardware, electrical and sealing components (not shown in FIG. 1 for simplicity) are then assembled to the steel inner panel 120. The various components of the interior trim panel 110, including lights, switches, armrests, map pockets, handles, etc., are assembled onto the interior trim panel 110. The assembled trim panel 110 is attached to the assembled inner panel 120, and the final electrical and hardware connections are made.

Recently, it has been proposed to use a plastic insert or core module to hold the various functional parts and devices of the door, such as the window regulator, door lock mechanisms, door handle, and speaker, just to name a few. See, for example, U.S. Pat. Nos. 6,857,688; 6,640,500; 6,546,674; 6,449,907; 5,820,191; 5,355,629; 5,040,335; 4,882,842; 4,648,208; and WO 01/25055 A1. Such parts and devices are pre-assembled on the core module, which is either inserted into a corresponding aperture formed in the outer panel or the inner panel. The pre-assembled core module reduces the OEM's costs and floor space expenses by transferring the assembly to a Tier supplier.

FIG. 2 shows a schematic illustration of a conventional door 200 having a plastic insert or core module 210 that fits into an aperture 202 formed in the outer panel 270. Numerous components are assembled to the core module 210, including an interior door handle 215, handle linking cables 220, motor 225, window regulator 230, speaker 235, guide rail 240, drum pulley 245, cable 250, and door latch unit 260. After these functional parts and devices are attached to the core module 210, the core module 210 is attached to the outer panel 270. The interior trim panel 280 is then attached to the outer panel 270.

Conventional core modules, such as that described above, are simply designed for the convenience of pre-assembling the numerous components of the door while minimizing floor space costs. As such, conventional core modules are not designed with safety in mind. In particular, conventional core modules are typically not designed to break and/or collapse in a controlled manner in the event of a side impact or intrusion. Such core modules are also not designed to provide energy absorption properties to protect passengers from side impact and/or intrusions.

Among other things, there is a need, therefore, for a core module having the capability of a controlled break and collapse in the event of a side impact and/or intrusion.

### SUMMARY OF THE INVENTION

A door core module is provided. In at least one specific embodiment, the core module includes a molded panel having two or more channels injection molded therein, and a plurality of notches formed in an upper surface of the panel. The notches are arranged about the panel to provide control break points. In at least one other specific embodiment, the core module includes a molded panel having two or more channels injection molded therein; one or more reinforcement members disposed within at least one of the two or more channels; and a plurality of notches formed in an upper surface of the panel arranged about the panel to provide control break points.

An integrated door system is also provided. In at least one specific embodiment, the integrated door system includes an outer panel, an inner panel, and a core module. The core module includes two or more channels injection molded therewith and a plurality of notches formed in an upper surface thereof. The notches are arranged about the core module to provide control break points. Further, the core module is adapted to attach to either the outer panel or the inner panel.

### BRIEF DESCRIPTION OF THE DRAWINGS

FIG. 1 is a schematic illustration of a conventional door as used in the prior art.

FIG. 2 is a schematic illustration of a conventional door having a plastic insert or core module that fits into an aperture formed in an outer panel of the door assembly as used in the prior art.

FIG. 3A is a schematic, partial sectional view of an illustrative core module according to one or more embodiments herein.

FIG. 3B is an enlarged, partial sectional view of two channels along a side of the core module shown in FIG. 3A.

FIG. 4A and FIG. 4B show illustrative, partial cross sectional views of one or more reinforcement members disposed within a channel to provide additional stiffness and strength.

FIG. 5 is a partial section view of an illustrative trim module having various components assembled thereon.

FIGS. 6A-C show a partial cross sectional view of one embodiment of a window lift system that can be used with the core module shown in FIG. 3A.

FIGS. 7A-C show a partial cross sectional view of another embodiment of a window lift system that can be used with the core module shown in FIG. 3A.

FIG. 8 shows a schematic, partial sectional view of an illustrative core module having one more channels, integrated window tracks and various integrated seals, plugs and grommets.

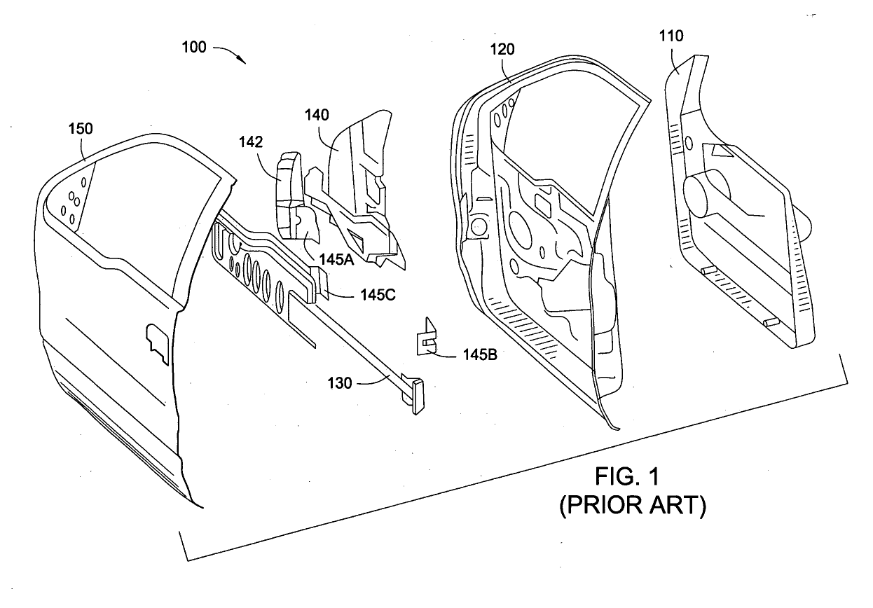

### DETAILED DESCRIPTION OF THE INVENTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

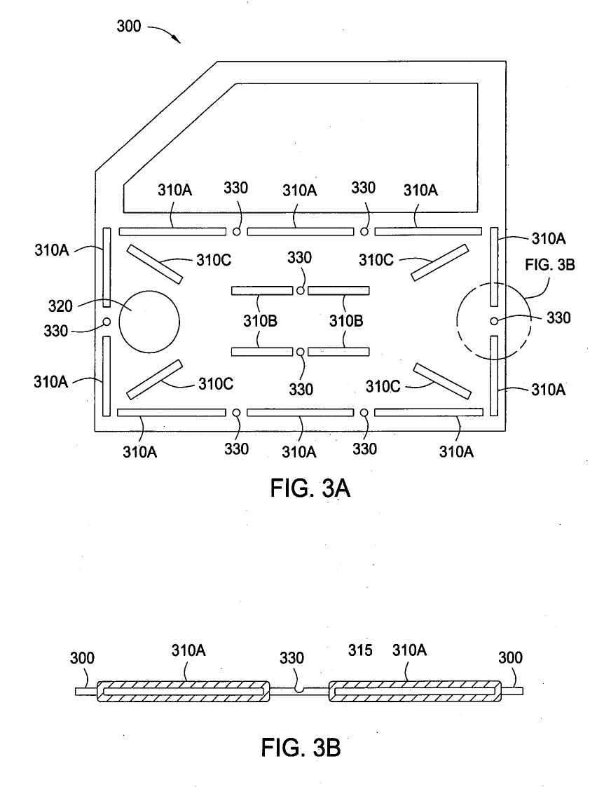

FIG. 3A is schematic, partial section view of an illustrative core module according to one or more embodiments herein. In at least one embodiment, a core module 300 with two or more disconnected channels 310A, 310B, 310C is provided. The channels 310A, 310B, 310C are preferably integrated with the core module 300. Any one or more of the channels 310A, 310B, 310C can be hollow or have hollow sections formed therein. In at least one embodiment, the channels 310A, 310B, 310C are structural members, and are designed to break and collapse in a controlled manner during side intrusion and/or impact. By “structural members” it is meant that the channels are designed to have strength and rigidity to meet automotive stiffness and safety standards.

The core module 300 can also include any one or more hardware, electrical parts, and sealing members attached thereto. Illustrative hardware can include window regulators, window tracks, windows, door locks, speakers, and impact bolsters. Certain electrical components can include wire harnesses, speakers, window motors, and outside mirror motors. Sealing components can include glass run channels, beltlines, lower sashes, plugs, grommets, and core to frame seals. The core module 300 is shown having a speaker box 320.

Considering the channels 310A, 310B, 310C in more detail, the channels 310A, 310B, 310C can be formed throughout the core module 300. In one or more embodiments above or elsewhere herein, a first set of one or more channels 310A can be formed about a perimeter of the module 300. In one or more embodiments above or elsewhere herein, a second set of one or more channels 310B can be formed about a central section of the module 300. In one or more embodiments above or elsewhere herein, a third set of one or more channels 310C can be formed about an intermediate section of the module 300. The “intermediate section” refers to the area or location between the central section of the core module 300 and adjacent to the channels 310A about the perimeter of the module 300.

Each channel 310A, 310B, 310C can be oriented in any position. In other words, any two or more channels 310A, 310B, 310C can be parallel, perpendicular or arranged at an angle in relation to one another. The angle can be in relation to either the vertical or the horizontal edges of the module 300. As shown, a first portion of the outer channels 310A is preferably formed parallel or substantially parallel to the top and bottom of the module 300, which is perpendicular or substantially perpendicular to the left and right sides of the module 300. A second portion of the outer channels 310A is preferably formed perpendicular or substantially perpendicular to the top and bottom sides of the module 300, which is parallel or substantially parallel to the left and right sides of the module 300. The one or more channels 310B about the central portion of the module 300 are preferably formed parallel or substantially parallel to the top and bottom of the module 300, as shown. Preferably, the one or more channels 310C are arranged at an angle relative to the top and bottom sides and the left and right sides of the module 300. For example, any one of the channels 310C can be formed at an angle of about 10 to about 60 degrees, preferably about 45 degrees, in relation to the top side of the module 300. In one or more embodiments, the channels 310C can be formed at an angle ranging from a low of about 10 degrees, 15 degrees, or 20 degrees to a high of about 40 degrees, 50 degrees, or 70 degrees.

Each of the channels 310A-C can have any shaped cross section. For example, the cross section of the channels 310A-C can be any one or more of the following: circular, oval, diamond, square, or rectangular, including any combination thereof. Preferably, the shape of the cross section is chosen to provide the desired structural integrity applicable for the application. As mentioned above, each of the channels 310A-C can be hollow to provide strength.

The channels 310A-C can be created by water or gas injection-molding, or other known techniques. The length and width of the channels 310A-C can vary depending on the desired strength and stiffness for the application (i.e., end-use). In one or more embodiments, the depth or height of the channels 310A-C can range from about 2 mm to about 50 mm. For example, the depth of the channels 310A-C can range from a low of about 2 mm, 5 mm, 10 mm, 15 mm, or 20 mm to a high of about 25 mm, 30 mm, 40 mm, or 50 mm. In one or more embodiments, the length of the channels 310A-C can range from about 4 mm to about 50 mm. For example, the length of the channels 310A-C can range from a low of about 4 mm, 5 mm, 10 mm, 15 mm, or 20 mm to a high of about 25 mm, 30 mm, 40 mm, or 50 mm.

In one or more embodiments above or elsewhere herein, at least one channel 310A-C can be enlarged to serve as the armrest (not shown in this view) of the door. For example, one of the interior channels 310B can be oversized using water or gas assist to give additional surface area which can serve as the armrest.

In one or more embodiments above or elsewhere herein, any one or more of the channels 310A-C can be filled or at least partially filled with a filler. For example, any one or more of the channels 310A-C can be at least partially filled with a foam like material. Suitable foam like materials include polyurethane, polyethylene, or polypropylene foam. Other suitable materials include expanded polypropylene bead.

FIG. 3B is an enlarged, cross sectional view of two channels 310A along a side of the core module 300 shown in FIG. 3A. As shown, the channels 310A are hollow and have a rectangular cross section.

In one or more embodiments above or elsewhere herein, the module 300 includes one or more notches or break points 330 formed therein, preferably between two or more channels 310A, B, C, as shown in FIG. 3B. Referring to FIGS. 3A and 3B, the notches 330 can be made in any shape, size, location, or thickness to provide the optimal performance for the desired application. The notches 330 are preferably configured to allow the core module 300 to absorb optimal energy loads, and allow the core module 300 to collapse, thereby preventing any lose or broken pieces from the core module 300.

The notches 330 reduce the wall thickness of the module 300 as shown in FIG. 3B. The reduced thickness presents a weakness in the module 300, which serves as a controlled break point upon a side intrusion or impact. As such, the integrity of the module 300 is compromised at each notch 330 location, thereby allowing the module 300 to break in a controlled and predictable manner. The location of the notches 330 can be arbitrary. However, the location of each notch 330 can be selected based on the most probable points of impact.

Preferably, the wall thickness of the module 300 ranges from about 1 mm to about 6 mm. In one or more embodiments, the depth of each notch 330 can vary to provide different strengths and/or integrity to better control the degree and position of a break. For example, notches 330 adjacent the outer channels 310A can have a depth of between about 0.25 mm and about 3 mm, which corresponds to a module 330 thickness of about 0.75 mm to about 5.75 mm. Similarly, notches 330 adjacent the inner channels 310B can have a depth of between about 0.25 mm and about 3 mm, which corresponds to a module 330 thickness of about 0.75 mm to about 5.75 mm. Notches 330 adjacent the intermediate channels 310C can have a depth of between about 0.25 mm and about 3 mm, which corresponds to a module 330 thickness of about 0.75 mm to about 5.75 mm.

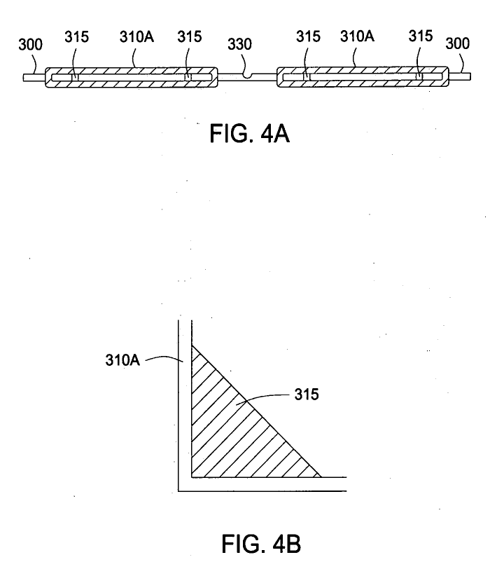

In one or more embodiments above or elsewhere herein, one or more reinforcement members can be added in any location, such as within any one or more of the channels 310A, 310B, 310C, if needed, to add additional strength. FIGS. 4A and 4B show illustrative, partial cross sectional views of channels 310A having one or more reinforcement members (e.g., ribs or fins) 315 disposed therein. Such ribs 315 can vary in thickness between about 1 mm and 3 mm depending on the strength desired. The ribs 315 can be integrally formed with the channels 310A-C using the injection molding or multi-material injection molding techniques as described. Robotic extrusion can also be used.

Preferably, the core module 300 is molded as one component and integrates all the applicable hardware, electrical, and sealing systems thereon. Due to its simplicity and high level of integration, the integrated core module 300 reduces the number of individual components (i.e., parts) and assembly steps required to produce a finished door. Preferably, multi-material injection molding technology and/or in-mold assembly techniques are used to integrate the various components into the core module 300. As such, the number of individual components requiring assembly is minimized, thereby reducing assembly time and floor space costs.

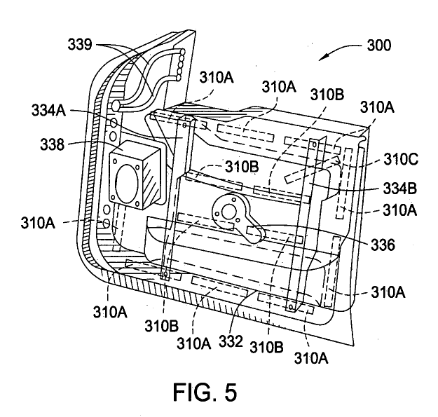

FIG. 5 is a partial section view of an illustrative core module 300 having one or more integrated parts formed thereon. Illustrative components include, but are not limited to window regulators, motors, and tracks; switches; door handles; door locks; impact bolsters; arm rests; map pockets; wire harnesses; speaker boxes or receptacles; speakers; window motors; outside mirror motors; beltline seals; lower sash seals; plugs; grommets; and core to frame seals.

Referring to FIG. 5, the core module 300 is shown having a map pocket 332, window tracks 334A, 334B, motor support 336, speaker box 338, and air distribution channel 339 for heat or air. Any of such components can be integrally formed with the core module 300. For example, the window tracks 334A,B are integrally formed with the core module 300 via injection molding. Assembly time and associated costs are greatly reduced because the window tracks 334A,B are an integral component of the core module 300, and not a separate component that requires separate assembly.

In one or more embodiments, a slip coating or strip (not shown) can be inserted into the mold where the tracks 334A, 334B are formed to reduce the friction on the track when the window moves up and down. The coating or strip can also be applied using robotic extrusion. The coating or strip can be any suitable material having a low coefficient of friction with the window glass, including one or more materials described herein.

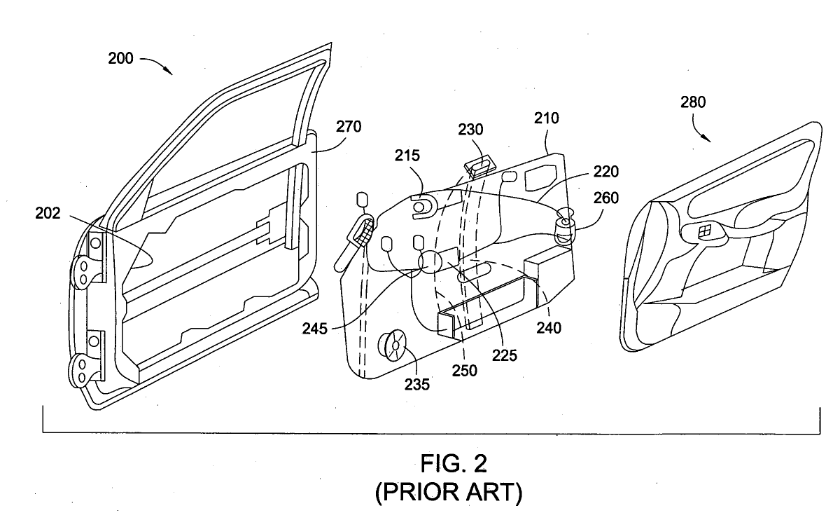

In one or more embodiments, a first portion of the air channel 339 can be formed in the core module 300 and a second portion of the air channel 339 can be formed in the adjacent panel such as the outer panel 270 (shown in FIG. 2) so that when the two panels are assembled, the two adjoining panels define the air channel 339 formed therebetween. As such, yet another component requiring assembly is eliminated.

The channels 310A, 310B, 310C can increase the material stiffness of the core module 300 by a factor of as much as three. Therefore, any one or more the channels 310A, 310B, 310C can be used to provide support or reinforcement for any one or more of the components (i.e., motors, windows, window tracks, etc.) on the core module 300.

In one of more embodiments above or elsewhere herein, the core module 300 is produced using multi-material or multi-shot injection molding techniques. Such techniques allow multiple materials to be injection molded into a single or multiple cavity mold. Any suitable multi-material injection molding machine can be used, such as Engel Victory Combi machine available from Engel Corp. As mentioned, additional processing techniques can be used alone or in combination to enhance and/or facilitate the integration. Illustrative techniques include multiple cavity tools, insert molding, movable core sections, gas/water assist, and robotic extrusion of seals into the injection mold.

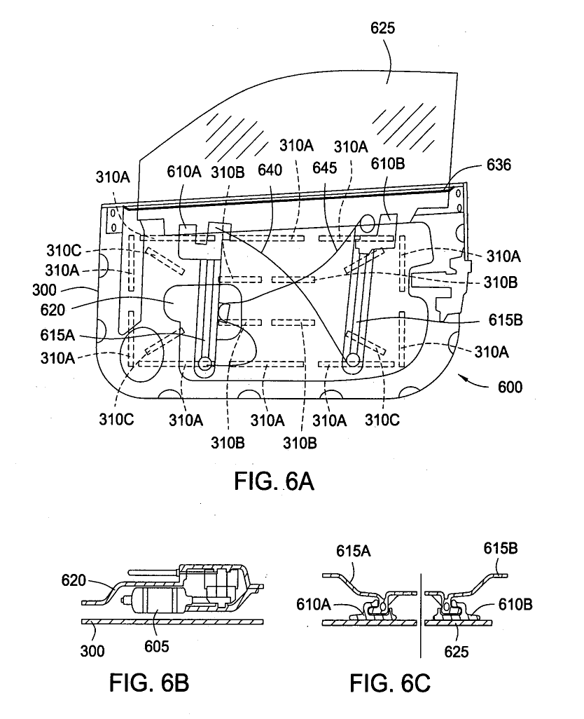

FIGS. 6A, 6B and 6C show a partial sectional view of the core module 300 having an illustrative window lift system 600 at least partially integrated therewith. The window lift system 600 includes a motor housing 620, two or more regulators (610A and 610B), and two or more track members 615A, 615B. The window lift system 600 further includes cables 640 and 645 in communication with the regulators 610A, 610B.

Referring to FIG. 6B, the motor housing 620 is preferably injection molded with the core module 300. The housing 620 can be molded on either the first (“interior”) or second (“exterior”) side of the core module 300, depending on design details. A motor 605 can be attached to the integrated motor housing or receptacle 620. The motor 605 can be easily mounted on or assembled to the motor housing 620 using a snap connection, rivet, screw, or by any other fastener (not shown).

Referring to FIG. 6C, the window 625 is secured to the regulators 610A, 610B by one or more fasteners and/or adhesive type material (not shown). The regulators 610A, 610B are each configured on a track member 615A, 615B. The regulators 610A, 610B and the window tracks 615A, 615B can each be formed to have mating profiles that when engaged, the regulator 610A or 610B is guided along the profile of its respective track 615A, 615B, as shown in FIGS. 6A and 6C.

Referring again to FIG. 6A, the cables 640 and 645 are tied to the regulators 610A, 610B. The regulators 610A, 610B move the window 625 up or down when the motor 620 alternately draws the cables 640 and 645. The window 625 is supported by the regulators 610A, 610B in communication with the integrally formed tracks 615A and 615B.

A belt line glass seal or sweep 636 can be integrally molded to the core module 300. The belt line glass seal 636 provides an additional weather seal to prevent water seeping into the door. A water management sheet (not shown), preferably formed of plastic such as polyethylene, polyurethane or a closed cell foam, can be attached to the interior side of the core module 300 to prevent water, noise and/or dust from entering the interior of the door into the passenger compartment.

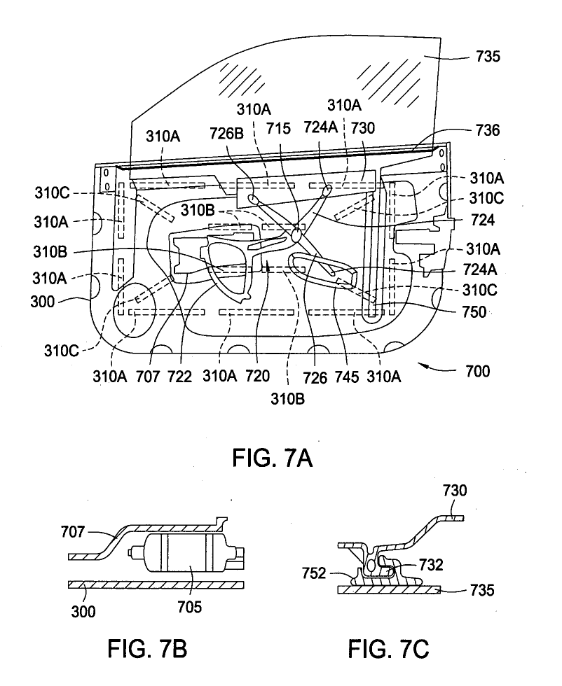

FIGS. 7A, 7B and 7C show a partial sectional view of the core module 300 having another illustrative window lift system 700 at least partially integrated therewith. In at least one embodiment, the window lift system 700 includes an integrated motor housing or receptacle 707, cross arm lifter 720, regulator 730, and integrated window tracks 745, 750. The cross arm lifter 720 includes a gear or toothed member 722, a first extension member 724 and a second extension member 726. The integrated motor housing or receptacle 707 is preferably injection molded with the core module 300. A lift motor 705 can be attached to the integrated housing or receptacle 707, as shown in FIG. 7B. The housing 620 can be molded on either the first (“interior”) or second (“exterior”) side of the core module 300, depending on design details. The motor 705 can be easily mounted on or assembled to the housing 707 using a snap connection, rivet, screw, or by any other fastener (not shown).

Referring again to FIGS. 7A and 7B, the motor 705 drives the toothed member 722 either clockwise or counterclockwise about a pivot point 715. The toothed member 722 is attached to or is integral with the first extension member 724. The first extension member 724 has a first end 724A that is attached to the regulator 730. The regulator 730 is attached to the bottom of the window glass 735. At least a portion of the regulator 730 is configured to fit within the integrally formed track 750. The track 750 is integrally formed with the core module 300 via injection molding as explained above. The regulator 730 and the window track 750 can each be formed to have mating profiles 732, 752 that when engaged, the regulator 730 is guided along the profile 752 of the track 750 as shown in FIG. 7C.

The first extension member 724 is pivotally connected at pivot point 715 to the second extension member 726. A first end 726A of the second extension member 726 communicates with the integrally formed track 745. A second end 726B of the second extension member 726 is attached to the regulator 730. The track 745 is integrally formed with the core module 300 via injection molding. As the motor 705 drives the toothed member 722, the extension members 724 and 726 work together via the pivot point 715 to raise or lower the regulator 730 and hence, the window glass 735.

In one or more embodiments above or elsewhere herein, a belt line seal or sweep 736 can be injection molded with the core module 300, as shown in FIG. 7A. The belt line glass seal 736 provides an additional weather seal. A water management sheet (not shown), preferably formed of plastic such as polyethylene, polyurethane or a closed cell foam, can be attached to the interior side of the core module 300 to prevent water, noise and/or dust from entering the interior of the door into the passenger compartment.

In one or more embodiments, the door system can include one or more integrated seals, plugs, and grommets to prevent or eliminate water seepage, rattles and vibration. Any one or more of the seals, plugs, and grommets can be directly molded onto the core module using known techniques, including two or three shot injection molding. Alternatively, any one or more of the seals, plugs, and grommets can be insert molded into the mold of the core module 300. For example, the core module can include one or more beltline seals, lower sash seals, plugs, grommets, and core to frame seals. Robotic extrusion can also be used to apply any one or more of the seals, plugs, and grommets.

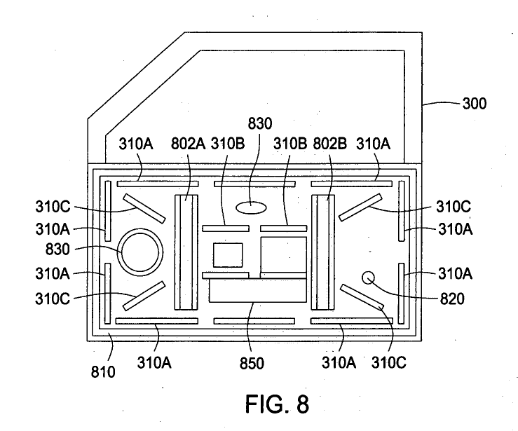

FIG. 8 shows a schematic partial section view of an illustrative core module having one more integrated window tracks 802A, 802B and various integrated seals 810, plugs 820 and grommets 830 to keep water out and prevent rattling/vibration. The seals 810, plugs 820, and grommets 830 are preferably molded onto the core module 300 using two or three shot injection molding.

In one or more embodiments above of elsewhere herein, the door system 300 can further include one or more crash pads or side bolsters 850, integrated therewith, as shown in FIG. 8. The side bolsters 850 can be foamed members, such as foam blocks. The side bolsters 850 can also be hollow structures. Preferably, the bolsters 850 are injection molded using a stiff material. The side bolster 850 can also be second shot molded onto the core module 300 using multi-injection molding techniques.

### Materials

The components described, including the core module, window tracks, seals, plugs, bolsters and grommets, can be made from any material having the requisite properties, such as stiffness and strength for example. Suitable materials include, but are not limited to, propylene homopolymers, propylene copolymers, ethylene homopolymers, ethylene copolymers, and or any one or more of the following polymer resins:
a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, nylon 66/PPS copolymer;
b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters;
c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS);
d) polymethacrylate resins such as polymethyl methacrylate and polyethylacrylate;
e) cellulose resins such as cellulose acetate and cellulose acetate butyrate;
f) fluorine resins such as polyvinylidene fluoride (PVDF), polyvinyl fluoride (PVF), polychlorofluoroethylene (PCTFE), and tetrafluoroethylene/ethylene copolymer (ETFE);
g) polyimide resins such as aromatic polyimides;
h) polysulfones;
i) polyacetals;
j) polyactones;
k) polyphenylene oxides and polyphenylene sulfides;
l) styrene-maleic anhydrides;
m) aromatic polyketones,
n) polycarbonates (PC);
o) elastomers such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like); and
p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, sand, glass beads, mineral aggregates, talc, and hydrotalcite compounds of the ions Mg, Ca, or Zn with Al, Cr, or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g., Kevlar or Twaron), meta-aramide fibers (e.g., Nomex), polyethylene fibers (e.g., Dyneema), and combinations thereof.

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Most preferred is a PP reinforced with a PET fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D-4703 Method B or ASTM D-1505, and a melt index (MI) between 0.10 dg/min and 30 dg/min according to ASTM D-1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D-1238. Preferred plastomers can have an average molecular weight of from 10,000 to 800,000 in one embodiment, and from 20,000 to 700,000 in another embodiment. The molecular weight distribution (Mw/Mn) of desirable plastomers ranges from 1.5 to 5 in one embodiment, and from 2.0 to 4 in another embodiment. The 1% secant flexural modulus (ASTM D-790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. Preferably, the copolymer has a density less than 0.915 g/cm³. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MPa. Further, preferred blends will have a flexural modulus of 1,750 MPa or more, such as about 1,800 MPa or more, or more than about 2,000 MPa.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

One of ordinary skill in the art will recognize that the door system described can be utilized as a complete system, or the individual components thereof can be utilized separately as individual mini-systems or modular type units to help consolidate two or more components if desired.

In another embodiment, this invention relates to:

1. A door core module, comprising:

a molded panel having two or more channels injection molded therein; and

a plurality of notches formed in an upper surface of the panel arranged about the panel to provide control break points.

### 2. The module of paragraph 1, wherein the notches are injection molded with the core module and the two or more channels.

### 3. The module of paragraph 1 or 2, wherein the inner panel includes an opening formed therein and the core module is adapted to cover the opening of the inner panel.

### 4. The module of paragraph 1, 2 or 3, wherein the outer panel includes an opening formed therein and the core module is adapted to cover the opening of the outer panel.

### 5. The module of any of paragraphs 1 to 4, wherein the core module is sandwiched between the inner panel and the outer panel to form the door system.

### 6. The module of any of paragraphs 1 to 5, wherein the core module includes one or more components attached thereto.

7. The module of any of paragraphs 1 to 6, wherein the core module includes one or more components attached thereto, the components selected from the group consisting of a window regulator, window track, window, door lock, speaker, impact bolster, wire harness, speaker, window motor, and outside mirror motor, glass run channel seal, beltline seal, lower sash seal, plugs, grommets, and core to frame seals.
8. A door core module, comprising:

a molded panel having two or more channels injection molded therein;

one or more reinforcement members disposed within at least one of the two or more channels; and

a plurality of notches formed in an upper surface of the panel arranged about the panel to provide control break points.

### 9. The core module of paragraph 8, wherein the notches are injection molded with the core module and the two or more channels.

### 10. The core module of paragraph 8 or 9, wherein the inner panel includes an opening formed therein and the core module is adapted to cover the opening of the inner panel.

### 11. The core module of paragraph 8, 9, or 10, wherein the outer panel includes an opening formed therein and the core module is adapted to cover the opening of the outer panel.

### 12. The core module of any of paragraphs 8 to 11, wherein the core module is sandwiched between the inner panel and the outer panel to form the door system.

### 13. The core module of any of paragraphs 8 to 12, wherein the core module includes one or more components attached thereto.

14. The core module of any of paragraphs 8 to 13, wherein the core module includes one or more components attached thereto, the components selected from the group consisting of a window regulator, window track, window, door lock, speaker, impact bolster, wire harness, speaker, window motor, and outside mirror motor, glass run channel seal, beltline seal, lower sash seal, plugs, grommets, and core to frame seals.

### 15. The core module of any of paragraphs 8 to 14, wherein the one or more reinforcement members are integrally formed with the two or more channels using injection molding or multi-material injection molding techniques.

### 16. The core module of any of paragraphs 8 to 15, wherein the one or more reinforcement members are formed within the two or more channels using robotic extrusion.

17. An integrated door system, comprising:

an outer panel;

an inner panel; and

a core module having two or more channels injection molded therewith and a plurality of notches formed in an upper surface thereof, the notches arranged about the core module to provide control break points,

wherein the core module is adapted to attach to either the outer panel or the inner panel.

### 18. The door system of paragraph 17, wherein the notches are injection molded with the core module and the two or more channels.

### 19. The door system of paragraph 17 or 18, wherein the inner panel includes an opening formed therein and the core module is adapted to cover the opening of the inner panel.

### 20. The door system of any of paragraphs 17 to 19, wherein the outer panel includes an opening formed therein and the core module is adapted to cover the opening of the outer panel.

### 21. The door system of any of paragraphs 17 to 20, wherein the core module is sandwiched between the inner panel and the outer panel to form the door system.

### 22. The door system of any of paragraphs 17 to 21, wherein the core module includes one or more components attached thereto.

23. The door system of any of paragraphs 17 to 22, wherein the core module includes one or more components attached thereto, the components selected from the group consisting of a window regulator, window track, window, door lock, speaker, impact bolster, wire harness, speaker, window motor, and outside mirror motor, glass run channel seal, beltline seal, lower sash seal, plugs, grommets, and core to frame seals.

### 24. The door system of any of paragraphs 17 to 23, further comprising one or more reinforcement members disposed within at least one of the two or more channels.

### 25. The door system of any of paragraphs 17 to 24, wherein the one or more reinforcement members are integrally formed with the two or more channels using injection molding or multi-material injection molding techniques.

### 26. The door system of paragraph 25, wherein the one or more reinforcement members are formed within the two or more channels using robotic extrusion.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

Although the foregoing has been described with reference to door systems for automobiles, it should be readily understood that the present invention can be applied to other automotive applications, such as instrument panels and front end modules. The present invention can also be applied to non-automotive applications that require a high degree of structural integrity, good energy management, and a mechanism to allow breakage or collapse in a controlled manner, such as road barriers for example.

While the foregoing is directed to embodiments of the present invention, other and further embodiments of the invention may be devised without departing from the basic scope thereof, and the scope thereof is determined by the claims that follow.

What is claimed is:

1. A door core module, comprising:
a molded panel having two or more channels injection molded therein; and
a plurality of notches formed in an upper surface of the panel arranged about the panel to provide control break points.

2. The module of claim 1, wherein the notches are injection molded with the core module and the two or more channels.

3. The module of claim 1, wherein the inner panel includes an opening formed therein and the core module is adapted to cover the opening of the inner panel.

4. The module of claim 1, wherein the outer panel includes an opening formed therein and the core module is adapted to cover the opening of the outer panel.

5. The module of claim 1, wherein the core module is sandwiched between the inner panel and the outer panel to form the door system.

6. The module of claim 1, wherein the core module includes one or more components attached thereto.

7. The module of claim 1, wherein the core module includes one or more components attached thereto, the components selected from the group consisting of a window regulator, window track, window, door lock, speaker, impact bolster, wire harness, window motor, outside mirror motor, glass run channel seal, beltline seal, lower sash seal, plugs, grommets, and core to frame seals.

8. A door core module, comprising:
a molded panel having two or more channels injection molded therein;
one or more reinforcement members disposed within at least one of the two or more channels; and
a plurality of notches formed in an upper surface of the panel arranged about the panel to provide control break points.

9. The core module of claim 8, wherein the notches are injection molded with the core module and the two or more channels.

10. The core module of claim 8, wherein the inner panel includes an opening formed therein and the core module is adapted to cover the opening of the inner panel.

11. The core module of claim 8, wherein the outer panel includes an opening formed therein and the core module is adapted to cover the opening of the outer panel.

12. The core module of claim 8, wherein the core module is sandwiched between the inner panel and the outer panel to form the door system.

13. The core module of claim 8, wherein the core module includes one or more components attached thereto.

14. The core module of claim 8, wherein the core module includes one or more components attached thereto, the components selected from the group consisting of a window regulator, window track, window, door lock, speaker, impact bolster, wire harness, window motor, outside mirror motor, glass run channel seal, beltline seal, lower sash seal, plugs, grommets, and core to frame seals.

15. The core module of claim 8, wherein the one or more reinforcement members are integrally formed with the two or more channels using injection molding or multi-material injection molding techniques.

16. The core module of claim 8, wherein the one or more reinforcement members are formed within the two or more channels using robotic extrusion.

17. An integrated door system, comprising:
an outer panel;
an inner panel; and
a core module having two or more channels injection molded therewith and a plurality of notches formed in an upper surface thereof, the notches arranged about the core module to provide control break points,
wherein the core module is adapted to attach to either the outer panel or the inner panel.

18. The door system of claim 17, wherein the notches are injection molded with the core module and the two or more channels.

19. The door system of claim 17, wherein the inner panel includes an opening formed therein and the core module is adapted to cover the opening of the inner panel.

20. The door system of claim 17, wherein the outer panel includes an opening formed therein and the core module is adapted to cover the opening of the outer panel.

21. The door system of claim 17, wherein the core module is sandwiched between the inner panel and the outer panel to form the door system.

22. The door system of claim 17, wherein the core module includes one or more components attached thereto.

23. The door system of claim 17, wherein the core module includes one or more components attached thereto, the components selected from the group consisting of a window regulator, window track, window, door lock, speaker, impact bolster, wire harness, window motor, outside mirror motor, glass run channel seal, beltline seal, lower sash seal, plugs, grommets, and core to frame seals.

24. The door system of claim 17, further comprising one or more reinforcement members disposed within at least one of the two or more channels.

25. The door system of claim 24, wherein the one or more reinforcement members are integrally formed with the two or more channels using injection molding or multi-material injection molding techniques.

26. The door system of claim 24, wherein the one or more reinforcement members are formed within the two or more channels using robotic extrusion
